(19) United States
(12) Patent Application Publication
(10) Pub. No.: US 2017/0132651 A1
(43) Pub. Date: May 11, 2017

(54) POOLED REWARD PROGRAM FOR MULTIPLE CONSUMERS

(71) Applicant: MASTERCARD INTERNATIONAL INCORPORATED, Purchase, NY (US)

(72) Inventors: Andres Guillermo Lopez, Yonkers, NY (US); Maria Fondeur Butler, New York, NY (US); Birce Arslan, Boston, MA (US); Tyler Welsh, Poway, CA (US); Stephen Parento, White Plains, NY (US)

(73) Assignee: MASTERCARD INTERNATIONAL INCORPORATED, Purchase, NY (US)

(21) Appl. No.: 14/935,621

(22) Filed: Nov. 9, 2015

(51) Int. Cl. G06Q 30/02

(52) U.S. Cl. CPC G06Q 30/0226

(57) ABSTRACT

Systems, methods, and devices for implementing a pooled reward program that incentivizes consumer spending by exploiting the competitive nature of humans are described. Multiple consumers form a reward program group. When a target (either consumer level or group level) is met or exceeded, at least one consumer of the group receives a reward/benefit. When the target is group level, at least one consumer with the highest value receives a benefit/reward when the group value meets or exceeds the target. When the target is consumer level, the consumer that meets or surpasses the target first receives the benefit/reward. Upon one or more of the consumers receiving the benefit/reward, the point values may be zeroed, and the competition may be started over.

### FIELD OF TECHNOLOGY

The present disclosure relates generally to electronic commerce, and more particularly to reward programs.

### BACKGROUND

Various consumer reward programs are presently implemented. Exemplary reward programs incentivize consumer purchasing by paying a consumer when the consumer's spend amount meets or exceeds a threshold value. For example, the consumer receives a $10 gift certificate when they spend $50. Other reward programs pay the consumer a percentage of a transaction purchase price depending on the type of transaction involved. For example, a transaction involving groceries may award the consumer 3% of the transaction price and a transaction involving fuel may award the consumer 1% of the transaction price.

While these traditional reward programs incentivize consumer purchasing, they are limited. For example, typical reward programs are conducted on an individual consumer basis. Thus, a consumer involved in one of these typical reward programs only spends when convenient or necessary.

### SUMMARY

Aspects of the present disclosure include systems, methods, and devices for implementing a pooled reward program that incentivizes consumer spending by exploiting the competitive nature of humans. Multiple consumers form a reward program group. At least one member of the group receives a benefit/reward based on a point, number of transactions, and/or spend amount. A consumer's amount (e.g., points, number of transactions, spend, etc.) is tracked on an individual consumer level and a group level (i.e., each consumer's amount within the group is pooled into a group level value). In an example, when a target is met or exceeded, at least one consumer of the group receives a reward/benefit. The target may be a group level target. For example, when the group point value meets or exceeds a threshold, the entire group receives a benefit/reward. The target may also be an individual consumer level target. For example, when a consumer's point value meets or exceeds a threshold, the consumer receives a benefit/reward. Upon one or more of the consumers receiving the benefit/reward, the point values may be zeroed, and the “competition” may be started over. Regardless of the target being group level or consumer level, the reward program of the present disclosure places the consumers of a group in a competition with other groups or with each other. This results in increased consumer spending because consumers are apt to purchase more to increase their likelihood of winning a benefit/reward over their fellow consumer.

An aspect of the present disclosure relates to a device for implementing a pooled reward program. The device is configured to create a group account having two or more consumer accounts, receive transaction data from a merchant point of sale (“POS”) device, increase a value of a consumer account of the two or more consumer accounts and a value of the group account using the received transaction data, and distribute a benefit to a consumer account of the two or more consumer accounts with the greatest value. The device may also zero the value of each consumer account and the group account upon distribution of the benefit, and identify the group account and a consumer account using the transaction data. Creation of the group account may include receiving an enrollment request from a first consumer device and transmitting an enrollment invitation to a second consumer device identified within the received enrollment request. The device may additionally receive an enrollment acceptance, including a payment card number, from the second consumer device.

Another aspect of the present disclosure relates to a system for implementing a pooled reward program. The system includes a program originator device configured to receive enrollment requests from group member devices, receive transaction data from a merchant POS device, determine whether the received transaction data indicates it is qualifying transaction data, increase a value of a reward program account in response to the transaction data being qualifying transaction data, and distribute a reward program benefit upon the value of the reward program account reaching a threshold. The enrollment requests include payment card data and the transaction data includes payment card data regarding a transacted payment card. The received enrollment requests may include an enrollment request transmitted from a first group member device that includes group originator and affiliate group member identifying information. The received enrollment requests may also include an enrollment request transmitted from a second group member device that includes group identifying information originally transmitted from the program originator device to the first group member device. The program originator device may further be configured to transmit an enrollment invitation to a second group member device using the affiliate group member identifying information. Increasing the value of the reward program account may include increasing the value of an individual consumer account affiliated with the transacted payment card. Increasing the value of the reward program account may also or alternatively include increasing the value of a group account affiliated with individual consumer accounts (at least one of the individual consumer account being affiliated with the transacted payment card). Increasing the value of the reward program account may additionally include increasing the account by a value of one (1) when number of transactions are tracked and increasing the account by a transacted currency amount when purchase amount is tracked.

A further aspect of the present disclosure relates to a method for implementing a pooled reward program that includes enrolling two or more consumers within a reward program group, receiving transaction data from a merchant POS device, determining whether the received transaction data is qualifying transaction data, increasing the value of an account of the reward program group when the received transaction data is qualifying transaction data, and distributing a reward when the value of an account of the reward program group reaches a predetermined threshold. Enrolling the consumers may include receiving an enrollment request from a group originator device, transmitting group identifying data to a group originator device, and receiving an enrollment request from at least one non-originator group member device. Enrolling the consumer may alternatively include receiving an enrollment request from a group originator device, transmitting an enrollment invitation to a non-originator group member device, and receiving an enrollment acceptance from the non-originator group member device. The method may further include storing the received transaction data within a database that houses payment card activity data and distributing a reward to multiple individual consumer accounts affiliated with the reward program group when the value of a reward program group account reaches a predetermined threshold. The predetermined threshold may be a number of transactions or a spend amount. The method may additionally include distributing a reward on a periodic schedule.

### BRIEF DESCRIPTION OF THE DRAWINGS

Embodiments of devices, systems, and methods are illustrated in the figures of the accompanying drawings which are meant to be exemplary and not limiting, in which like references are intended to refer to like or corresponding parts, and in which:

FIG. 1 illustrates an overview system for implementing a pooled reward program according to the present disclosure;

FIG. 2 illustrates a system flow diagram according to the pooled reward program according to the present disclosure;

FIG. 3 illustrates a system for processing payments and tracking reward program values according to the present disclosure;

FIG. 4 illustrates a process flow diagram detailing a method for creating a pooled reward program group according to the present disclosure; and

FIG. 5 illustrates a process flow diagram detailing a method for tracking group values and distributing benefits/rewards according to the present disclosure.

### DEFINITIONS

The term “portable consumer device” (“PCD”) means a portable device capable of and configured to engage in consumer transactions. A non-limiting list of PCDs includes a card or payment card, personal digital assistance, computer, tablet, or smartphone.

The terms “card” and “payment card” means a card that can be presented by a consumer to make a payment or that can be used to make a payment in a remote transaction, such as an e-commerce transaction, telephone transaction, or mail order, for example. For example, the cards described herein may be a credit card, debit card, charge card, stored-value card, prepaid card, a gift card, and/or any other device that may hold payment account information, such as mobile phones, smartphones, personal digital assistants (PDAs), key fobs, and/or computers.

The term “card-not-present (“CNP”) transaction” means a transaction performed without physically presenting the card to a merchant. Common card not present transactions include e-commerce transactions, which are performed between remote parties over the Internet, mail order transactions and telephone order transactions, for example.

### DETAILED DESCRIPTION

The detailed description of aspects of the present disclosure set forth herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, references to a singular embodiment may include plural embodiments, and references to more than one component may include a singular embodiment.

The present disclosure provides systems, methods, and devices for implementing a pooled reward program that incentivizes consumer spending. Multiple consumers form a reward program group and at least one member of the group receives a benefit/reward when a threshold is met or exceeded. This exploits human competitive nature, resulting in increased consumer spending because consumers are apt to purchase more to increase their likelihood of winning a benefit/reward over their fellow consumer. The threshold may be calculated on an individual consumer or group level. For example, when a group point value meets or exceeds a threshold, the entire group receives a benefit/reward. In another example, when a consumer's point value meets or exceeds a threshold, the consumer receives a benefit/reward. Upon one or more of the consumers receiving the benefit/reward, the point values may be zeroed, and the “competition” may be started over.

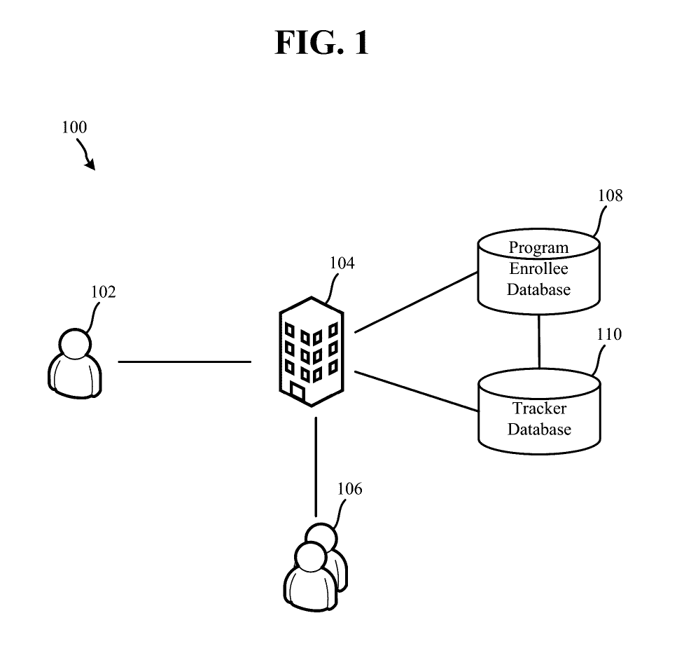

Referring to FIG. 1, an overview system 100 for implementing the pooled reward program is described. A consumer 102 engages a program originator 104 for enrollment within the pooled reward program. The program originator 104 may be a financial institution such as a bank, retail establishment, or payment card network or originator, for example. The program originator 104 may also be a service provider (i.e., a mobile phone service provider) or any other individual or entity interested in changing behavior on a group consumer level. When the consumer 102 signs up for the pooled reward program, the consumer 102 may identify one or more other consumers 106 (e.g., relatives, friends, or colleagues of the consumer 102) to be included within a single reward program group. To sign up, the consumer 102 provides the program originator 104 with identifying information of the consumer 102, and optionally identifying information of the other consumers 106 of the group. Such identifying information may include name, address, and payment card number, for example. The consumer 102 may provide the other consumers 106 of the group with group identifying information so the other consumers 106 may sign up for the group. Alternatively, the program originator 104 may send invites to the other consumers 106 identified to be within the group.

The program originator 104 is in communication with a program enrollee database 108 and a tracker database 110. The program enrollee database 108 includes consumer identifying information regarding consumers 102, 106 enrolled in the pooled reward program. The consumer identifying information includes name, address, and card number, for example. As stated herein, multiple consumers 102, 106 are affiliated with a single program group. Thus, the program enrollee database 108 may be segmented by reward program groups and/or by consumer line items, with the line items of consumers within a single group being affiliated. The tracker database 110 includes information specific to groups and/or the individuals regarding incentive tracking. For example, points, transaction numbers, and/or spend amount may be tracked on a group, consumer, and/or card number basis.

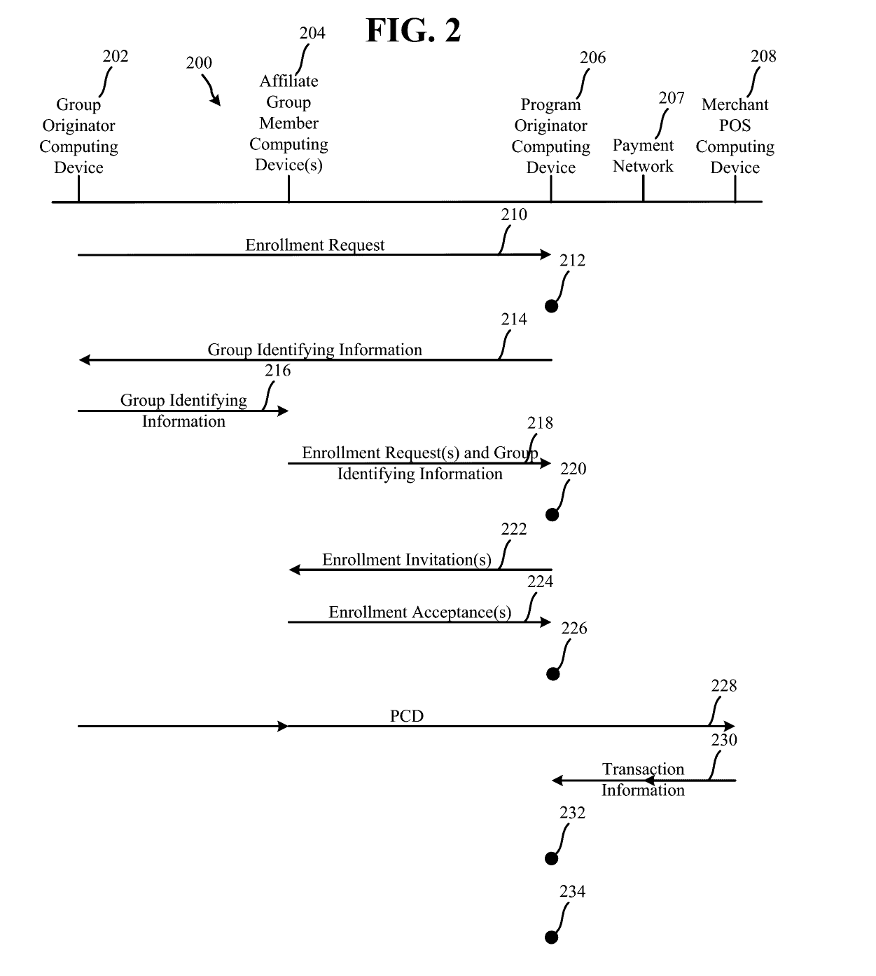

Attention is now given to FIG. 2, which illustrates a system flow 200 according to the pooled reward program. The system flow 200 includes a group originator computing device 202, affiliate group member computing device(s) 204, the program originator computing device 206, and a merchant point-of-sale (“POS”) computing device 208. The group originator computing device 202 transmits an enrollment request 210 to the program originator computing device 206. The enrollment request 210 may include group originator and affiliate group member identifying information, such as name, address, email, and card number, for example. The program originator computing device 206 creates a group account that includes a group originator account (illustrated as point 212). The program originator computing device 206 also transmits group identifying information 214 to the group originator computing device 202.

The group originator computing device 202 may transmit the group identifying information 216 to the affiliate group member computing device(s) 204. Affiliate group member computing devices 204 interested in being part of the pooled reward program transmit enrollment requests including the group identifying information 218 to the program originator computing device 206. The program originator computer device 206 thereby creates a group member account within the group account for each enrollment request received from an affiliate group member computing device 204 (illustrated as point 220). Alternatively, instead of system flows 216, 218, and 220, the program originator computing device 206 may transmit an enrollment invitation 222 to each of the affiliate group member computing devices 204 identified at system flow 210. In response, each affiliate group member computing device 204 interested in being part of the pooled reward program transmits an enrollment acceptance 224 to the program originator computing device 206. Thereafter, the program originator 206 creates a member account within the group account for each affiliate group member computing device 204 that accepted an enrollment invitation (illustrated as point 226).

A group originator and/or affiliate group members may present a PCD 228 at a merchant to pay for a transaction using the merchant POS computing device 208. Alternatively, the merchant POS computing device 208 may conduct a purchase using a card number during a card-not-present (“CNP”) transaction (not illustrated). In either case, the merchant POS computing device 208 transmits transaction information to a payment network 207, which transmits some or all of the transaction information to the program originator computing device 206 (collectively illustrated as 230). The transaction information 230 may include, for example, PCD or card number, transaction amount, transaction item description(s), and consumer identifying information such as name and address. The program originator computing device 206 stores some or all of the received transaction information within a reward program database (such as the tracker database 110). The program originator computing device also affiliates the transaction information with a specific group of the reward program and with a specific consumer (e.g., the consumer affiliated with the payment card or number used in the transaction) (illustrated as 232).

The program originator computing device 206 awards a single group member of the group a benefit/reward at a determined interval (illustrated as 234). For example, the benefit/reward may be issued on a periodic schedule (e.g., daily, weekly, bi-weekly, monthly, semi-annually, annually, or the like). When the benefit/reward is determined using a group value (i.e., overall group points, number of transactions, spend amount, etc.), the benefit/reward may be issued to a group member who engaged in the most transactions, spent the most money, or who received the most points, for example. When the benefit/reward is determined using individual member values within a group, the benefit/reward may be issued to the first group member whose number of transactions, money spent, or points met or surpassed a threshold value pre-determined by the program originator computing device 206. Alternatively, the threshold value may be set by the group originator computing device 202 when the enrollment request (illustrated as 210) is sent. Upon distribution of the benefit/reward, group and/or individual member values may be zeroed, and the “competition” may be started over.

Increasing the point value of an individual group member's account may involve using card number data (or other consumer/card identifying data) to obtain transaction activity for that group member stored within a database or other storage location housing card activity data. Qualifying transactions are thereafter searched and data from qualifying transactions are pulled and used to increase the member's account (i.e., if one transaction, then add 1 to number of transactions completed by the member). The same concept may be applied if purchase amount/dollars are tracked instead of number of transactions.

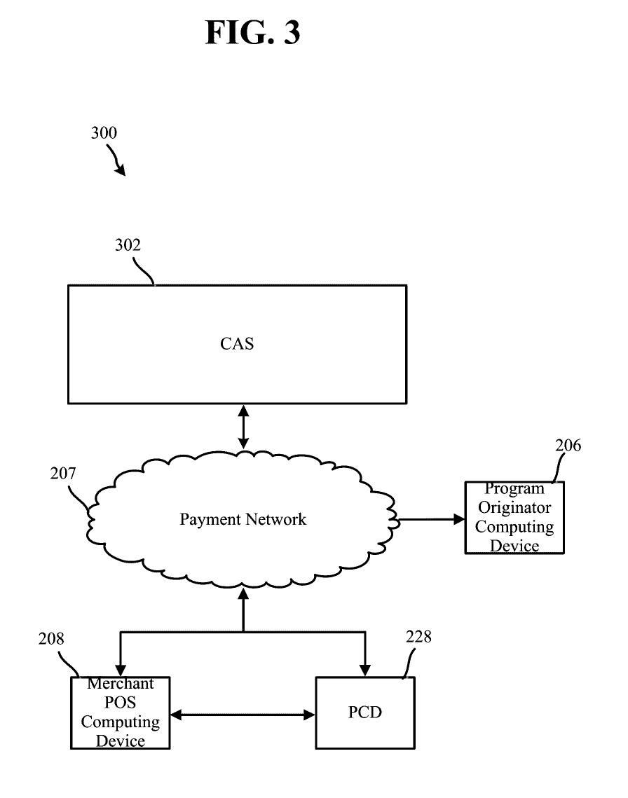

Referring to FIG. 3, a system 300 for processing payments and tracking reward program values is described. The system 300 includes a Card Authorization System (“CAS”) 302, the payment network 207, the PCD 228, the merchant POS computing device 208, and the program originator computer device 206. The various system components may communicate via the payment network 207.

The payment network 207 is configured to communicate with merchant POS computing devices 208 through various payment acquirers (not shown). The payment network 207 also communicates with payment card issuers and cardholders.

The CAS 302 is configured to perform all or part of an authorization process in relation to a payment transaction associated with a transaction account. The CAS 302 may comprise any combination of hardware and software, such as servers, databases, firewalls, computers, etc., in order to authorize transactions. In an unillustrated example, the CAS 302 is operated by the program originator 104, which also operates the program originator computer device 206. Furthermore, in another unillustrated example, the CAS 302 and the program originator computer device 206 may be a single device or system of devices that perform the functions and operations of the CAS 302 and the program originator computing device 206 individually described in detail herein.

The PCD 228 (or a card number if it is a CNP transaction) is presented to the merchant POS computing device 208 for pay for a transaction. Transaction information is transmitted through an acquirer to the payment network 207, which transmits some or all of the transaction information to the CAS 302. The CAS 302 authorizes the transaction using the received transaction information and an account affiliated with the PCD 228. Upon completion of the transaction, the payment network 207 transmits the transaction information to the program originator computer device 206. The program originator computing device 206 thereby stores some or all of the transaction information within a pooled reward program database. Within the pooled reward program database, the received transaction information is affiliated with a specific group member (i.e., the group member affiliated with the PCD 228). The program originator computer device 206 may be located at and controlled by a payment card issuer or at an operator of the payment network 207, for example.

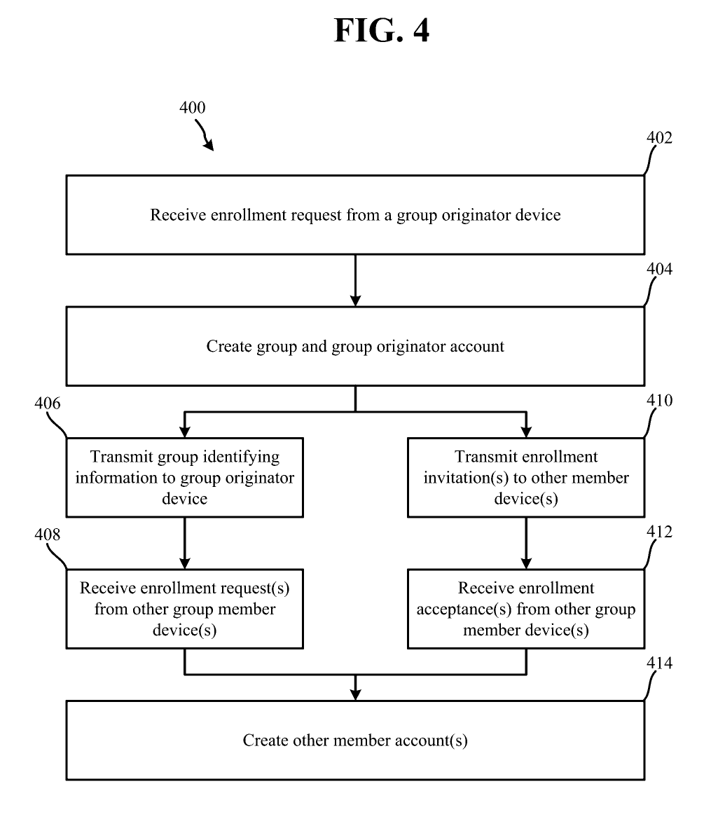

Attention is now given to FIG. 4, which illustrates a method 400 for creating a pooled reward program group according to the present disclosure. At block 402 an enrollment request is received from a group originator device. The enrollment request may include information used to identify the group originator and other group member(s). Such identifying information may include name, address, email, and payment card number, for example. The enrollment request may also include a proposed threshold value, desired by the group originator, to be used for determining benefit/reward distributions. This proposed threshold value may need approval prior to utilization. At block 404 a group containing an group originator account is created.

At block 406 group identifying information is transmitted to the group originator device. At block 408 enrollment requests are received from other group member devices. These enrollment requests may include group identifying information and other group member identifying information. Alternatively, instead of blocks 406 and 408, enrollment invitation(s) may be sent to other member device(s) identified by the group originator device at block 402 (illustrated as block 410). At block 412, enrollment acceptance(s) are received from the other member device(s). These enrollment acceptances may include other member identifying information and group identifying information. At block 414 a member account is created for each enrollment request received at block 408 and/or each enrollment acceptance received at block 412.

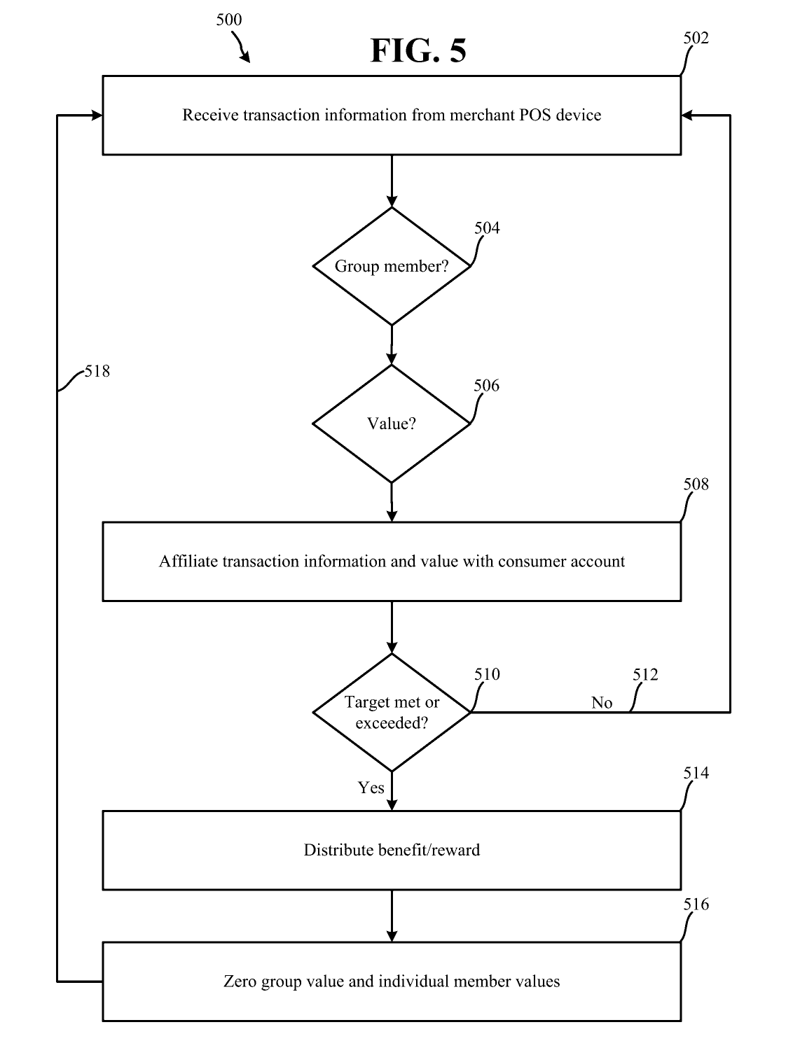

Attention should now be given to FIG. 5, illustrating a method 500 for tracking group values and distributing benefits/rewards. At block 502 transaction information is received from a merchant POS device. The transaction information may include, for example, PCD or card number, transaction amount, transaction item description(s), and consumer identifying information such as name and address.

The transaction information is used to determine if the consumer engaged in the transaction is an enrolled member of the pooled reward program (illustrated as decision point 504). The transaction information is also used to determine a value (e.g., transaction amount, points, a value of 1 if account value measured in number of transactions) to be added to the group member's present account value (illustrated as decision point 506). Increasing the value of a member's account may involve using card number data (or other consumer/card identifying data) to obtain transaction activity for that member stored within a database or other storage location housing card activity data. Qualifying transactions are thereafter searched and data from qualifying transactions are pulled and used to increase the member account (i.e., if one transaction, then add 1 to number of transactions completed by the consumer). The same concept may be applied if purchase amount/dollars are tracked instead of number of transactions.

At block 508 the transaction information and determined value (illustrated as decision point 506) are affiliated with the determined group member's (illustrated as decision point 504) account.

At decision point 510 it is determined whether a target value set for the group has been met or exceeded. The target value may be proposed by a group member originator and optionally approved by the reward program's originator, or the target value may be set by the reward program's originator. The target value may be a group level target (i.e., a value measured against a group value that is the sum of the individual group members' values) or the target value may be measured on an individual group member level. If the target has not been met or surpassed, the process is repeated (illustrated as arrow 512). If the target has been met or exceeded, a benefit/reward is distributed (illustrated as block 514). For example, when the target is group level, one or more of the group members with the greatest individual value receives the benefit/reward. For further example, when the target is individual level, the individual that meets or exceeds the target first receives the benefit/reward. At block 516 the group value and the individual values of the members therein are zeroed. Upon zeroing, the process is repeated (illustrated as arrow 518).

Systems, methods, and computer program products are provided according to the disclosure. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

Embodiments of the present disclosure are described herein with reference to the accompanying drawings. However, the present disclosure should not be construed as limited to the embodiments set forth herein. Rather, these embodiments are provided so that this disclosure will be thorough and complete, and will fully convey the scope of the present disclosure to those skilled in the art. Like numbers refer to like elements throughout. As used herein, the term “and/or” includes any and all combinations of one or more of the associated listed items and may be abbreviated as “/”.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises,” “comprising,” “having,” “includes,” “including,” and/or variations thereof, when used in this specification, specify the presence of stated features, steps, operations, elements, and/or components, but do not preclude the presence or addition of one or more other features, steps, operations, elements, components, and/or groups thereof.

It should be understood that when an element is referred to as being “connected” or “coupled” to another element (or variations thereof), it can be directly connected or coupled to the other element or intervening elements may be present. In contrast, when an element is referred to as being “directly connected” or “directly coupled” to another element (or variations thereof), there are no intervening elements present.

It will be understood that, although the terms first, second, etc. may be used herein to describe various elements and/or components, these elements and/or components should not be limited by these terms. These terms are only used to distinguish one element and/or component from another element and/or component. Thus, a first element or component discussed below could be termed a second element or component without departing from the teaching of the present disclosure.

The computer systems and servers described herein each contain a memory that will configure associated processors to implement methods, steps, and functions described. Such methods, steps, and functions can be carried out, e.g., by processing capability on various system elements or by any combination of elements. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more aspects of a system can include a computer program comprising computer program code means adapted to perform one or more steps described when such program is run on a computer, and that such program may be embodied on a tangible computer readable recordable storage medium; for example, in the form of distinct software modules which then execute on one or more hardware processors. Further, a system can include a computer comprising code adapted to cause the computer to carry out one or more steps, together with one or more apparatus elements or features.

Computers discussed herein can be interconnected, for example, by one or more of network, another virtual private network (VPN), the Internet, a local area and/or wide area network (LAN and/or WAN), via an EDI layer, and so on. The computers can be programmed, for example, in compiled, interpreted, object-oriented, assembly, and/or machine languages, for example, one or more of C, C++, Java, Visual Basic, and the like (an exemplary and non-limiting list), and can also make use of, for example, Extensible Markup Language (XML), known application programs such as relational database applications, spreadsheets, and the like. The computers can be programmed to implement the methods, steps and logic described.

As described herein a network may include any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse, combinations thereof and/or any suitable communication or data input modality.

Various databases used herein may include: consumer data; third party institution data; and/or like data useful in the operation of the system. As those skilled in the art will appreciate, the consumer may use a computer in the method described and the user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers.

The present system or any part(s) or function(s) thereof may be implemented using hardware, software or a combination thereof and may be implemented in one or more specially configured computer systems or other processing systems. However, the manipulations performed by embodiments were often referred to in terms, such as assessing, determining, matching or selecting, which are commonly associated with mental operations performed by a human operator. No such capability of a human operator is necessary in any of the operations described herein. Rather, the operations are machine operations performed by the specially configured machine or system operating according to the disclosure. After reading this description, it will become apparent to a person skilled in the relevant art(s) how to implement various embodiments by specially configuring other computer systems and/or architectures.

Any such computer system also includes a main memory, such as for example random access memory (RAM), and may also include a secondary memory or a removable storage unit. Removable storage unit represents a floppy disk, magnetic tape, optical disk, etc. which is read by and written to by removable storage drive. As will be appreciated, the removable storage unit includes a computer usable storage medium having stored therein computer software and/or data.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, software may be implemented in hardware components such as application specific integrated circuits (ASICs). Implementation of a hardware state machine to perform the functions described herein will be apparent to persons skilled in the relevant art(s).

Databases or data warehouses discussed herein may include relational, hierarchical, graphical, or object-oriented structure and/or any of various other particularly structured database configurations implementing data storage for the specially configured machine/system. Moreover, the databases may be organized as data tables or lookup tables. Each record may be a single file, a series of files, a linked series of data fields or other data structure. Association of certain data may be accomplished through desired data association techniques such as those known or practiced in the art.

As will be appreciated by one of ordinary skill in the art, the specially configured system according to the disclosure may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware.

The system and method is described herein with reference to block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows, steps described and the descriptions thereof may comprise configurations of and make reference to user windows, pop-up windows, webpages, websites, web forms, prompts, or the like.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. It should be appreciated that in the appended claims, reference to an element in the singular is not intended to mean “one and only one” unless explicitly so stated, but rather “one or more.”

Although illustrative embodiments of the present disclosure have been described herein with reference to the accompanying drawings, it is to be understood that the present disclosure is not limited to those precise embodiments, and that various other changes and modifications may be made by one skilled in the art without departing from the scope or spirit of the disclosure.

What is claimed is:

1. A device for implementing a pooled reward program, comprising:
a memory;
at least one processor operatively coupled to the memory; and
a persistent storage device operatively coupled to the memory and storing in a non-transitory manner instructions that when loaded into the memory cause the at least one processor to be operative to:
create a group reward account having a plurality of member reward accounts;
receive transaction data from a payment network, the payment network receiving the transaction data from a merchant point of sale (POS) device;
increase a value of a member reward account of the plurality of member reward accounts and a value of the group reward account using the transaction data; and
distribute a benefit to a member reward account of the plurality of member reward accounts with the greatest value.

2. The device of claim 1, wherein the at least one processor is further operative to zero the value of each of the plurality of member reward accounts and the value of the group reward account upon distribution of the benefit.

3. The device of claim 1, wherein the at least one processor is further operative to identify the group reward account and a member reward account of the plurality of member reward accounts using the transaction data.

4. The device of claim 1, wherein creation of the group reward account having a plurality of member reward accounts includes receiving an enrollment request from a first group member device and transmitting an enrollment invitation to a second group member device identified within the enrollment request.

5. The device of claim 4, wherein the at least one processor is further operative to receive an enrollment acceptance from the second group member device, the enrollment acceptance including a payment card number.

6. A specially configured computing system for implementing a pooled reward program, comprising:
a program originator device, the program originator device including a memory, at least one processor operatively coupled to the memory, and a persistent storage device operatively coupled to the memory and storing in a non-transitory manner instructions that when loaded into the memory cause the at least one processor to be operative to:
receive enrollment requests from group member devices, the enrollment requests including payment card data;
receive transaction data from a payment card network, the transaction data including payment card data regarding a transacted payment card;
determine whether the transaction data indicates it is qualifying transaction data;
increase a value of a member reward program account in response to the transaction data being qualifying transaction data; and
distribute a reward program benefit upon the value of the member reward program account reaching a threshold.

7. The specially configured computing system of claim 6, wherein an enrollment request received from a first group member device includes group originator and affiliate group member identifying information.

8. The specially configured computing system of claim 7, wherein an enrollment request received from a second group member device includes group identifying information transmitted to the first group member device by the program originator device in response to the program originator device creating a reward program group including the group originator and at least one affiliate group member.

9. The specially configured computing system of claim 7, wherein the at least one processor is further operative to transmit an enrollment invitation to a second group member device using the affiliate group member identifying information.

10. The specially configured computing system of claim 7, wherein increasing the value of a reward program account includes increasing the value of an individual group member account, the individual group member account being affiliated with the transacted payment card.

11. The specially configured computing system of claim 7, wherein increasing the value of a reward program account includes increasing the value of a group account, the group account being affiliated with individual group member accounts, at least one of the individual group member accounts being affiliated with the transacted payment card.

12. The specially configured computing system of claim 7, wherein increasing the value of a reward program account includes increasing the account by a value of one (1) when number of transactions are tracked.

13. The specially configured computing system of claim 7, wherein increasing the value of the reward program account includes increasing the account by a transacted currency amount evidenced within the received transaction data when purchase amount is tracked.

14. A method for implementing a pooled reward program, comprising the steps of:
enrolling a plurality of consumers within a reward program group;
receiving transaction data from a payment card network;
determining whether the received transaction data is qualifying transaction data;
increasing the value of a reward account of a plurality of reward accounts affiliated with the reward program group when the received transaction data is qualifying transaction data; and
distributing a reward when the value of a reward account of the plurality of reward accounts reaches a predetermined threshold.

15. The method of claim 14, wherein enrolling the plurality of consumers includes receiving an enrollment request from a group originator device, transmitting group identifying information to the group originator device, and receiving an enrollment request from a non-originator group member device.

16. The method of claim 14, wherein enrolling the plurality of consumers includes receiving an enrollment request from a group originator device, transmitting an enrollment invitation to a non-originator group member device, and receiving an enrollment acceptance from the non-originator group member device.

17. The method of claim 14, further comprising the step of:
storing the received transaction data within a database, the database including payment card activity data.

18. The method of claim 14, wherein the predetermined threshold is one of a number of transactions or a spend amount.

19. The method of claim 14, further comprising the step of:
distributing a reward to multiple individual reward accounts affiliated with the reward program group when the value of a reward program group account reaches a predetermined threshold.

20. The method of claim 14, further comprising the step of:
distributing a reward on a periodic schedule.
